(19) United States
(12) Patent Application Publication
(10) Pub. No.: US 2022/0058716 A1
(43) Pub. Date: Feb. 24, 2022

(54) Commodity recommendation system based on actionable high utility negative sequential rules mining and its working method

(71) Applicant: QILU UNIVERSITY OF TECHNOLOGY, Jinan (CN)

(72) Inventors: Xiangjun DONG, Jinan (CN); Mengjiao ZHANG, Jinan (CN)

(21) Appl. No.: 17/458,829

(22) Filed: Aug. 27, 2021

Related U.S. Application Data
(63) Continuation of application No. PCT/CN2020/129274, filed on Nov. 17, 2020.

(30) Foreign Application Priority Data
Aug. 18, 2020 (CN) 202010832287.X

(51) Int. Cl. G06Q 30/06; G06F 16/23; G06F 16/25; G06F 16/2458; G06Q 30/02; G06Q 10/08; H04L 29/08

(52) U.S. Cl. CPC G06Q 30/0631; G06F 16/2379; G06F 16/258; G06F 16/2465; H04L 67/12; G06Q 30/0204; G06Q 30/0633; G06Q 10/087; G06Q 30/0201

(57) ABSTRACT

A commodity recommendation system based on actionable high utility negative sequential rules mining and its working method comprises information acquisition module, commodity recommendation module, and commodity sales module that are sequentially connected, with the information acquisition module used to extract and store in real time the customer behavior data and transmit the data to the commodity recommendation module; the commodity recommendation module used to conduct data cleaning for the collected customer behavior data and classify the data after such cleaning and analyze and forecast the customers' shopping behaviors following the process as follows: create a shopping behavior sequence corresponding to the customer ID and the shopping behavior data of customers of the same sex and in the same age range constitute a sequence database, and conduct data mining for the sequence database to get desirable actionable high utility negative sequential rules.

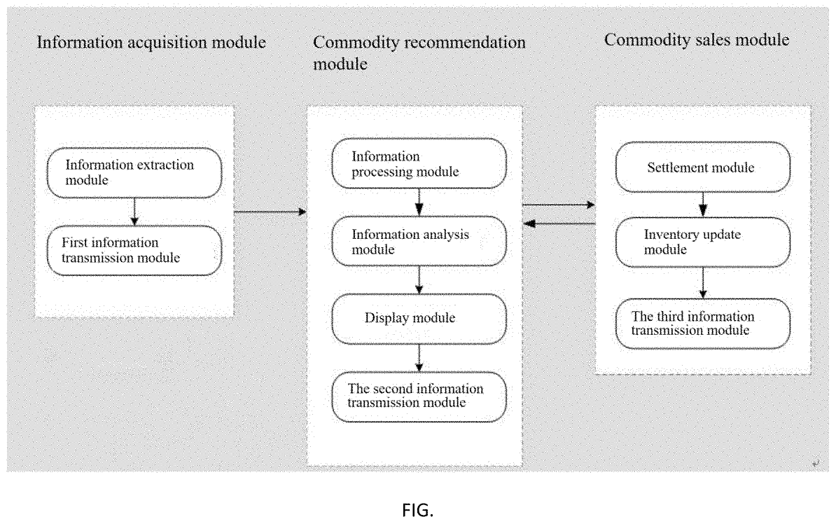

### CROSS REFERENCES

This application is the Continuation of International Application No. PCT/CN2020/129274 Filed on 17 Nov. 2020 which designated the U.S. and claims priority to Chinese Application No. 202010832287.X filed on 18 Aug. 2020, the entire contents of each of which are hereby incorporated by reference.

A commodity recommendation system based on actionable high utility negative sequential rules mining and its working method

### TECHNICAL FIELD

The invention is related to a commodity recommendation system based on actionable high utility negative sequential rules mining and its working method and belongs to the technical field of application of actionable high utility negative sequential rules.

### BACKGROUND ART

Driven by the popularization of the Internet technology, online e-commerce has achieved rapid development. It has its unique advantages that it can identify different users according to their accounts, browser cookies, and so on, and then recommend commodities to them according to their browsing history and purchase history. However, it also has its shortcomings, one of which is that the products recommended by it obviously cannot meet the users' needs sometimes. In addition, offline stores are still an important way to sell goods, though they are impossible to achieve commodity recommendation and corresponding user experience like online e-commerce due to lack of intelligence. Therefore, it is an urgent problem to figure out how to make accurate commodity recommendation for users in offline stores by intelligent means so that users can obtain a user experience similar to that of online e-commerce. Although the existing commodity recommendation methods can obtain a lot of data, a large part of them is redundant or even contradictory. It is very difficult to filter out useless information. Additionally, how to make use of the advantages of offline stores to collect customer information and conduct efficient analysis so as to obtain the recommendation information that can be directly used for decision-making is a technical problem to overcome.

As an important step of Knowledge-Discovery in Databases (KDD), data mining aims to discover effective, novel, potentially useful, and ultimately understandable patterns from a large amount of data. It is generally related to computer science and achieves the said goals through statistics, online analytic processing, information retrieval, machine learning, expert system (relying on past empirical rules), and pattern recognition. At present, data mining is the main computer means to effectively process and utilize massive digital information and also the main method to solve the problem of information overload and knowledge shortage in the information age.

High utility negative sequential rules mining is a very important research field in data mining. Compared with the traditional association rules mining, it not only considers the statistical significance of items but also considers the semantic measurement of items, thus expressing the needs of the real world more clearly. In such a mining algorithm, each item can be assigned a different utility weight, the number of occurrences of each item will be recorded, and items can appear repeatedly in each transaction, which is more in line with the supply and demand of the real world.

### DESCRIPTION OF THE INVENTION

In view of the shortcomings of existing technologies, the invention has presented a commodity recommendation system based on actionable high utility negative sequential rules mining to find more negative sequential rules that can be used for decision making.

The invention has also presented a working method of the said commodity recommendation system based on actionable high utility negative sequential rules mining.

The invention has proposed an efficient algorithm called AUNSRM to mine actionable high utility negative sequential rules. By applying the AUNSRM algorithm to commodity recommendation, the negative correlations between commodities can be found, thus providing decision support for customer product recommendation.

### Term Interpretation:

1. e-HUNSR algorithm: A very efficient high-utility mining algorithm for high utility negative sequential rules, which defines how to mine high utility negative sequential rules for the first time, and uses utility confidence to measure the usefulness of the rules. It also has presented the concrete implementation methods of how to generate candidate rules, how to store necessary information, and how to trim unwanted rules.
2. Hash table: Hash table is a data structure that can be accessed directly based on a Key value.
3. Utility: Utility represents the sum of the number of items in a sequence multiplied by the unit utility of the items.
4. Minimum utility: Minimum utility, abbreviated as min_utility, is the user-set minimum utility that a high-utility sequence satisfies and also the critical value used to distinguish a high-utility use sequence from a low-utility use sequence.
5. Utility confidence: uconf represents the ratio between the local utility of item-set X in item-set X∪Y and the utility of item-set X in the database in the high-utility sequential rules R: X→Y, which means the ratio of the utility contribution that the item-set X makes to the occurrence of the item-set X∪Y and its total utility.
6. Minimum utility confidence: Minimum uconf, abbreviated as min_uconf, is the minimum utility confidence that a high utility negative sequential rule satisfies.
7. Support: support represents the ratio of the number of occurrences of a sequence or rule in the database to the total number of sequences in the database.
8. High utility negative sequential rule: High Utility Negative Sequential Rule, abbreviated as HUNSR, is a negative sequential rule that satisfies both the minimum utility and the minimum utility confidence. For example, given the utility and utility confidence of the negative sequential rule ¬ab⇒c are 420 and 1 respectively, if the set minimum utility and minimum utility confidence are 200 and 0.25 respectively, then ¬ab⇒c is right a high utility negative sequential rule.

### The Technical Solution of the Invention is as Follows:

A commodity recommendation system based on actionable high utility negative sequential rules mining, which comprises information acquisition module, commodity recommendation module, and commodity sales module connected sequentially through the transmission network communication;

The said information acquisition module comprises information extraction module and the first information transmission module which are sequentially connected;

The said information extraction module is used to: extract and store in real time the customer behavior data which includes customer ID, face mark, age, gender, timestamp, and mark of the commodity browsed by the customer. The said first information transmission module is used to: transmit the customers' behavior data to the said commodity recommendation module through the transmission network;

The said commodity recommendation module comprises information processing module, information analysis module, display module, and the second information transmission module which are connected sequentially; the said commodity recommendation module is set up in the cloud server, with the said first information transmission module connecting to the said information processing module;

The said information processing module is used to: conduct data cleaning for the collected customer behavior data and classify the data after such cleaning, as the real-world data are generally incomplete, noisy, and inconsistent. The said information analysis module is used to: analyze and forecast the customers' shopping behaviors according to the treatment results of the said information processing module. The specific process is as follows: the said information analysis module creates a shopping behavior sequence corresponding to the customer ID based on the customer behavior data treated by the said information processing module and then analyzes and predicts the shopping behaviors; the shopping behavior data of customers of the same sex and in the same age range constitute a sequence database, with each customer ID corresponding to an ordered sequence formed by all the shopping records of a customer during a certain period of time; then, the module will conduct data mining for the sequence database to get desirable actionable high utility negative sequential rules, namely commodity recommendation that meets the customer's needs. The said display module is used to: display the recommendation results for the customer, including the commodity ID, model, quantity, and unit price, and adds them to the shopping cart if the customer is satisfied; otherwise, the recommendation results will be discarded. The said second information transmission module is used to: transmit the treatment results of the said commodity recommendation module to the said commodity sales module through the transmission network.

The said commodity sales module comprises settlement module, inventory update module, and the third information transmission module which are connected sequentially.

The said commodity sales module is set up in the cloud server, with the said third information transmission module used to connect the said commodity recommendation module; the said settlement module used to: settle accounts for the commodities in the shopping cart according to the treatment results of the said commodity recommendation module while the customer is going to the checkout counter for settlement; and the said inventory update module used to: update the commodity inventory in real time after the order is successfully settled. Additionally, the said commodity sales module also caches the customer's shopping behavior data this time and gives back the shopping record in real time to the said commodity recommendation module via the said third information transmission module. In this way, the data in the commodity recommendation module can be maintained up to date so as to ensure that the results recommended by the system are more accurate and more in line with the customer's needs.

According to a preferred embodiment of the invention, the said transmission network can be a wired network, LAN, Wi-Fi, personal network, or 4G/5G network.

The invention adopts cloud management platform design which needs no complex offline hardware configuration and is simple and easy to operate as it has set up both the commodity recommendation module and the commodity sales module in the cloud server. In this way, offline store outlets do not need to be configured with separate servers any more, and instead, they can upload and download data and retrieve information cloud data storage anytime and anywhere by renting the cloud management platform server of the system directly, which not only can reduce data loss rate, but also can reduce operating costs and unnecessary expenses. The system can also be deployed in a company's internal private cloud, either in the firewall of the company's data center or in a secure hosting place. It can make full use of the existing hardware and software resources to greatly reduce the costs of the company and provide the most effective control over data, security and service quality without affecting the company's existing IT management processes.

A working method of the said commodity recommendation system based on actionable high utility negative sequential rules mining, which comprises steps as follows:
(1) The said information extraction module extracts and stores in real time the customer behavior data which includes customer ID, face mark, gender, age, timestamp, and mark of the commodity browsed by the customer. Among them, face marks include whether to wear glasses and the coordinate positions of the eyes.
(2) The said first information transmission module transmits the customer behavior data extracted by the information acquisition module as said in Step (1) to the said commodity recommendation module through the transmission network;
(3) The said information processing module conducts data cleaning for the collected customer behavior data and classifies the data after such cleaning;
(4) The said information analysis module analyzes and predicts the customers' shopping behaviors according to the treatment results of the said information processing module. The specific process is as follows: the said information analysis module creates a shopping behavior sequence corresponding to the customer ID based on the customer behavior data treated by the said information processing module and then analyzes and predicts the shopping behaviors; the shopping behavior data of customers of the same sex and in the same age range constitute a sequence database, with each customer ID corresponding to an ordered sequence formed by all the shopping records of a customer during a certain period of time; then, the module will conduct data mining for the sequence database to get the desirable actionable high utility negative sequential rules, namely commodity recommendation that meets the customer's needs.
(5) Based on the commodity recommendation in line with the customer's needs obtained from Step (4), the said display module displays the recommendation results for the customer, including the commodity ID, model, quantity, and unit price, and adds them to the shopping cart if the customer is satisfied; otherwise, the recommendation results will be discarded.
(6) The said second information transmission module transmits the treatment results of the said commodity recommendation module to the said commodity sales module through the transmission network.
(7) While the customer is going to the checkout counter for settlement, the said settlement module settles accounts for the commodities in the shopping cart according to the treatment results of the said commodity recommendation module; then, the said inventory update module updates the commodity inventory in real time after the order is successfully settled; the said commodity sales module also caches the customer's shopping behavior data this time and gives back the shopping record in real time to the said commodity recommendation module via the said third information transmission module.

According to a preferred embodiment of the invention, in Step (3), as the real-world data are generally incomplete, noisy, and inconsistent, missing, duplicate and inconsistent data may occur when the customer behavior data are collected through the information acquisition module. For example, information cross exists between customer C2 and C3. The said information processing module conducts data cleaning for the collected customer behavior data; the specific process is as follows: For missing data, the range of missing data is determined, the unwanted fields are removed, and the missing content is filled in; for duplicate data, delete the others and retain only one; for inconsistent data, conduct data filling.

According to a preferred embodiment of the invention, the classification of the cleaned data based on the gender and age of the customers in Step (3) is a specific process as follows: the behavior data of customers of the same sex and in the same age range make up a database, while the behavior data of customers of different genders or different age groups make up different databases which are independent of each other and each of which contains all the behavior data of this type of customers. For example, the database of female customers with age falling within the range of 20-25 contains customer shopping records as follows: C1, Nov. 20, 2010, Female, 21 years old, Textured fashionable handbag with a chain, Brown, Quantity: 1; C2, Nov. 21, 2010, Female, 25 years old, Summer floral dress, Blue, Quantity: 1.

According to a preferred embodiment of the invention, the said information analysis module analyzes and predicts the customer behavior data through the AUNSRM algorithm in Step (4), which comprises steps as follows:
A. Mine the utility sequence database through the high utility negative sequential rule mining method and the e-HunSR algorithm to obtain all high utility negative sequential rules, which are rules that the value of customer's purchase sequences is greater than a certain value, and calculate the utility and utility confidence of each high utility negative sequential rule; then, store the information obtained from the high utility negative rules in two hash tables respectively, with key1 in the first Hash Table representing the high utility negative sequential rule, value1 representing the utility of the corresponding high utility negative sequential rule and key2 in the second Hash Table representing the high utility negative sequential rule and value2 representing the utility confidence of the corresponding high utility negative sequential rule. For example, as for the high utility negative sequential rule R=a¬b⇒d (utility=1350, uconf=80%)R=a¬b⇒c1, it means the customers who have bought commodity A first, no commodity B, and then commodity D and spends a total of 1350 CNY in the utility sequence database with utility confidence of 80%. Under the premise of a minimum utility of 1000 and a minimum utility confidence of 60%, we can conclude that: when it is found that a customer has bought commodity A but no commodity B, if we timely recommend commodity D to the customer, we will have an 80% chance to get a higher profit.

According to a preferred embodiment of the invention, the utility sequence database in Step A is transformed from the database obtained after the data classification in Step (3). The specific method is as follows: First, find all the shopping behavior data containing the customer ID from the database with the customer ID as the primary key, wherein the customer's shopping behavior data refer to the data given back to the said commodity recommendation module by the said commodity sales module via the said third information transmission module, including timestamp, customer ID, commodity ID, quantity, and unit price; then, combine the shopping behavior data with the same customer ID, namely remove the timestamp (shopping time), keep the customer ID as the first field, and make up the second field by sorting the commodities purchased by the customer in chronological order by ID and quantity; additionally, the unit price of each commodity will be kept separately; thus, the utility sequence database corresponding to different genders and different age intervals is obtained.

According to a preferred embodiment of the invention, the mining of high utility negative sequential rules from the utility sequence database through the high utility negative sequential rules mining method and the e-HUNSR algorithm in Step A comprises steps as follows:
a. Utilize the HUNSPM algorithm to mine the utility sequence database to get all the high-utility negative sequential patterns and save their utility values, wherein the high-utility negative sequential pattern refers to a utility negative sequential pattern with a utility being greater than or equal to the minimum utility; For example, given the utility of <a¬bcd¬e>as 20, then it is right a high-utility negative sequential pattern if the minimum utility is set as 18.
b. Obtain all candidate rules based on the high-utility negative sequential patterns generated by Step a, following the specific method as follows: divide the high-utility negative sequential pattern into two parts, namely the front part and the rear part; for example, the candidate rules corresponding to <a¬bcd¬e> are: a⇒bcd¬e, a¬b⇒cd¬e, a¬bc⇒d¬e, and a¬bc⇒d¬e.
c. Delete the candidate rule wherein its front part or rear part contains only one negative item; for example, among the candidate rules corresponding to <a¬bcd¬e>, the rule a¬bcd⇒¬e should be deleted, as its rear part contains only one negative item, while the other candidate rules shall be preserved.
d. Calculate the utility confidence of the remaining candidate rules, and those with utility confidence larger than the minimum utility confidence are right the desired high utility negative sequential rules.
B. Filter the actionable high utility negative sequential rules: filter the high utility negative rules based on support, rule inclusion criteria, and utility; filter each high utility negative rule in the order of support, rule inclusion criteria, and utility, which comprises steps as follows:

Assuming that there are high utility negative sequential rules R=X⇒Y and Ri=Xi⇒Yi, wherein R and Ri represent two different high utility negative sequential rules respectively, X represents the front part of R while Y represents the rear part of R, and Xi represents the front part of Ri while Yi represents the rear part of Ri the high utility negative sequential rule R is an actionable high utility negative sequential rule relative to Ri if the following three conditions \textcircled{1}, \textcircled{2} and \textcircled{3} are fulfilled. By deleting all Ri and retaining all R, then all actionable high utility negative sequential rules that fulfill the conditions \textcircled{1}, \textcircled{2} and \textcircled{3}, namely commodity recommendation that meets the customer's needs, can be obtained.
R and Ri have the same support;
When R=X⇒Y is compared with Ri=Xi⇒Yi; Ri⊆R, X⊆Xi, Yi⊆Y;
u(Ri)≤u(R), where u(Ri) refers to the utility of Ri and u(R) refers to the utility of R;

According to a further preferred embodiment of the invention, the support of R in condition \textcircled{1} shall be calculated with the formula as shown in equation (I):

$$sup ( X ⇒ Y ) = \frac{sup ( X Y )}{\vert D \vert} \qquad ( I )$$

Where: |D| represents the number of tuples in sequence database D, wherein the tuple is expressed as <sid(sequence-ID), ds (data sequence)>; sequence-ID, abbreviated as sid, represents the ID of each sequence, for example C1, C2, and C3 in Table 2; data sequence, abbreviated as ds, represents the corresponding sequence; for example, the ds corresponding to C1 is <(a,1){(c,3)(e,5}>, the ds corresponding to C2 is <{(b,2)(c,3)(d,1)}{(a,2)(d,5)}> and the ds corresponding to C3 is <{(b,5)(e,3)}(a,3)>; X∞Y represents the connection between X and Y; sup(X∞Y) represents the number of tuples that contain X∞Y in the sequence database D;

The support of Ri shall be calculated with the formula as shown in equation (II):

$$sup ( X i ⇒ Y i ) = \frac{sup ( Xi Yi )}{\vert D \vert} \qquad ( II )$$

Where: Xi∞Yi represents the connection between Xi and Yi; sup(Xi∞Yi) represents the number of tuples that contain Xi∞Yi in the sequence database D.

According to a further preferred embodiment of the invention, assuming in condition \textcircled{2} that R=ac⇒be and Ri=ac⇒b, if <ac⇒b>⊆<ac⇒be>, ac⊆, b⊆be, wherein R and Ri represent two different high utility negative sequential rules respectively, ac represents the front part of R, be represents the rear part of R, ac represents the front part of Ri, and b represents the rear part of Ri, then these two rules satisfy the condition \textcircled{2}.

According to a further preferred embodiment of the invention, for the rule R=X⇒Y in condition \textcircled{3}, if <e₁e₂e₃ . . . eᵢ₋₁> represents the front part X and the <eᵢ . . . eₖ> represents the rear part Y, then the rule should be expressed as R=<e₁e₂e₃ . . . eᵢ₋₁>⇒<eᵢ . . . eₖ>;

The utility u(R) of the rule R shall be calculated with the formula as shown in equation (III):

u(R)=Σᵢ₌₁^{k}u(eᵢ) (III)

Where: i=1, 2, 3 . . . k, eᵢ∈R, u(eᵢ)=q(eᵢ, R)×p(e); q(eᵢ, R) represents the internal utility of item eᵢ and p(eᵢ) represents the external utility of item eᵢ;

As for the rule Ri=Xi⇒Yi, assuming that <e₁e₂e₃ . . . eⱼ₋₁> represents the front part Xi and <eᵢ . . . eₖ> represents the rear part Yi, then the rule can be expressed as Ri=<e₁e₂e₃ . . . eᵢ₋₁>⇒<eᵢ . . . eₖ>;

The utility u(Ri) of the rule Ri shall be calculated with the formula as shown in equation (IV):

$$u ( R i ) = {\sum }_{j = 1}^{k} u ( {e}_{j} ) \qquad ( IV )$$

Where: j=1, 2, 3 . . . k, eⱼ∈Ri, u(eⱼ)=q(eⱼ, R)×p(eⱼ); q(eⱼ, R) represents the internal utility of item eⱼ and p(eⱼ) represents the external utility of item

The Beneficial Effects of the Invention are as Follows:
1. The existing high utility negative sequential rule mining algorithms can obtain a particularly large number of rules and many of them are mutually contradictory or redundant rules, so they make no sense for decision making and instead, they have made useful rules harder to discover. The invention has presented an actionable high utility negative rule mining algorithm—AUNSRM algorithm, which takes into account not only the statistical correlation between things, but also the semantic meanings between things, and thus can remove many useless rules and get more meaningful rules that can be directly used to make decisions. It can provide scientific decision support against the customers' follow-up shopping behaviors for the industry of commodity recommendation behavior analysis.
2. The invention is applied in the analysis of commodity recommendation behavior and adapts to the characteristics of the commodity recommendation industry that pays attention not only to the commodity type but also to the commodity value. When providing suggestions to customers, the invention can find interesting rules from the historical shopping records, and provide prediction and support for the customers' follow-up shopping behaviors.

### BRIEF DESCRIPTION OF THE FIGURES

FIGURE is the structure block diagram of the commodity recommendation system based on actionable high utility negative sequential rules mining in the invention.

### DETAILED EMBODIMENTS

The invention is further described in combination with the attached figures and embodiments as follows, but is not limited to that.

### Embodiment 1

A commodity recommendation system based on actionable high utility negative sequential rules mining, as shown in FIGURE, which comprises information acquisition module, commodity recommendation module and commodity sales module connected sequentially through the transmission network communication;

The information acquisition module comprises information extraction module and the first information transmission module which are sequentially connected, with the information extraction module used to: extract and store in real time the customer behavior data which includes customer ID, face mark, gender, age, timestamp, and mark of the commodity browsed by the customer; and the first information transmission module used to: transmit the customers' behavior data to the commodity recommendation module through the transmission network;

The commodity recommendation module comprises information processing module, information analysis module, display module, and the second information transmission module which are connected sequentially. The commodity recommendation module is set up in the cloud server, with all information processing modules connected by the first information transmission module. The information processing module is used to: conduct data cleaning for the collected customer behavior data and classify the data after such cleaning, as the real-world data are generally incomplete, noisy, and inconsistent. The information analysis module is used to: analyze and forecast the customers' shopping behaviors according to the treatment results of the information processing module; the specific process is as follows: the information analysis module creates a shopping behavior sequence corresponding to the customer ID based on the customer behavior data treated by the information processing module and then analyzes and predicts the shopping behaviors; the shopping behavior data of customers of the same sex and in the same age range constitute a sequence database, with each customer ID corresponding to an ordered sequence formed by all the shopping records of a customer during a certain period of time; then, the module will conduct data mining for the sequence database to get desirable actionable high utility negative sequential rules, namely commodity recommendation that meets the customer's needs. The display module is used to: display the recommendation results for the customer, including the commodity ID, model, quantity, and unit price, and adds them to the shopping cart if the customer is satisfied; otherwise, the recommendation results will be discarded. The second information transmission module is used to: transmit the treatment results of the commodity recommendation module to the commodity sales module through the transmission network.

The commodity sales module comprises settlement module, inventory update module, and the third information transmission module which are connected sequentially. The commodity sales module is set up in the cloud server, with the third information transmission module used to connect the commodity recommendation module; the settlement module used to: settle accounts for the commodities in the shopping cart according to the treatment results of the commodity recommendation module while the customer is going to the checkout counter for settlement; and the inventory update module used to: update the commodity inventory in real time after the order is successfully settled. Additionally, the commodity sales module also caches the customer's shopping behavior data this time and gives back the shopping record in real time to the commodity recommendation module via the third information transmission module. In this way, the data in the commodity recommendation module can be maintained up to date so as to ensure that the results recommended by the system are more accurate and more in line with the customer's needs.

The transmission network can be a wired network, LAN, Wi-Fi, personal network, or 4G/5G network.

The invention adopts cloud management platform design which needs no complex offline hardware configuration and is simple and easy to operate as it has set up both the commodity recommendation module and the commodity sales module in the cloud server. In this way, offline store outlets do not need to be configured with separate servers any more, and instead, they can upload and download data and retrieve information cloud data storage anytime and anywhere by renting the cloud management platform server of the system directly, which not only can reduce data loss rate, but also can reduce operating costs and unnecessary expenses. The system can also be deployed in a company's internal private cloud, either in the firewall of the company's data center or in a secure hosting place. It can make full use of the existing hardware and software resources to greatly reduce the costs of the company and provide the most effective control over data, security and service quality without affecting the company's existing IT management processes.

### Embodiment 2

A working method of the commodity recommendation system based on actionable high utility negative sequential rules mining as described in Embodiment 1, which comprises the following steps:
(1) The information extraction module extracts and stores in real time the customer behavior data which includes customer ID, face mark, gender, age, timestamp, and mark of the commodity browsed by the customer. Among them, face marks include whether to wear glasses and the coordinate positions of the eyes.
(2) The first information transmission module transmits the customer behavior data extracted by the information acquisition module as said in Step (1) to the commodity recommendation module through the transmission network;
(3) The information processing module conducts data cleaning for the collected customer behavior data and classifies the data after such cleaning;
(4) The information analysis module analyzes and predicts the customers' shopping behaviors according to the treatment results of the information processing module. The specific process is as follows: the information analysis module creates a shopping behavior sequence corresponding to the customer ID based on the customer behavior data treated by the information processing module and then analyzes and predicts the shopping behaviors; the shopping behavior data of customers of the same sex and in the same age range constitute a sequence database, with each customer ID corresponding to an ordered sequence formed by all the shopping records of a customer during a certain period of time; then, the module will conduct data mining for the sequence database to get the desirable actionable high utility negative sequential rules, namely commodity recommendation that meets the customers' needs.
(5) Based on the commodity recommendation in line with the customer's needs obtained from Step (4), the display module displays the recommendation results for the customer, including the commodity ID, model, quantity, and unit price, and adds them to the shopping cart if the customer is satisfied; otherwise, the recommendation results will be discarded.
(6) The second information transmission module transmits the treatment results of the commodity recommendation module to the commodity sales module through the transmission network.
(7) While the customer is going to the checkout counter for settlement, the settlement module settles accounts for the commodities in the shopping cart according to the treatment results of the commodity recommendation module; then, the inventory update module updates the commodity inventory in real time after the order is successfully settled; the commodity sales module also caches the customer's shopping behavior data this time and gives back the shopping record in real time to the commodity recommendation module via the third information transmission module.

### Embodiment 3

A working method of the commodity recommendation system based on actionable high utility negative sequential rules mining as described in Embodiment 2, which comprises steps as follows:

The embodiment uses the shopping data records of snacks sold in an off-line store of a shopping mall as its experimental data. Table 1 and Table 2 show part of the results of the utility sequence databases and the utility table respectively after the shopping behavior data of the customers being preprocessed and cleared up.

TABLE 1

| Customer | |
|---|---|
| ID | Shopping sequence |
| C1 | <(Walnut kernel, 1000 g) (Badam, 3000 g)> |
| C2 | <(Pecan, 2000 g)(Walnut kernel, 1000 g)(Spicy |
| | hot dried bean curd, 200 g)> |
| C3 | <(Dried mango, 500 g)(Dried strawberry, 300 g)> |
| . . . | . . . |

TABLE 2

| | | | | Spicy hot | |
|---|---|---|---|---|---|
| | Walnut | | Dried | dried bean | Dried |
| Item | kernel | Pecan | strawberry | curd | mango |
| Unit utility | 166.9 | 146 | 150 | 113 | 216 |
| (yuan/1 kg) | | | | | |

In Step (3), as the real-world data are generally incomplete, noisy, and inconsistent, missing, duplicate and inconsistent data may occur when the customer behavior data are collected through the information acquisition module. For example, information cross exists between customer C2 and C3. The information processing module conducts data cleaning for the collected customer behavior data; the specific process is as follows: for missing data, the range of missing data is determined, the unwanted fields are removed, and the missing content is filled in; for duplicate data, delete the others and retain only one; for inconsistent data, conduct data filling.

The classification of the cleaned data based on the gender and age of the customers in Step (3) is a specific process as follows: the behavior data of customers of the same sex and in the same age range make up a database, while the behavior data of customers of different genders or different age groups make up different databases which are independent of each other and each of which contains all the behavior data of this type of customers. For example, the database of female customers with age falling within the range of 18-22 contains customer shopping records as follows: C1, Oct. 20, 2019, Female, 20 years old, Dried strawberry, 1000 g; C2, Jan. 14, 2020, Female, 22 years old, Spicy hot dried bean curd, 2000 g.

The information analysis module analyzes and predicts the customer behavior data through the AUNSRM algorithm with the minimum utility min_util=300 and the minimum utility confidence min_uconf=0.55 in Step (4), which comprises steps as follows:
A. Mine the utility sequence database through the high utility negative sequential rule mining method and the e-HunSR algorithm to obtain all high utility negative sequential rules, which are rules that the value of customer's purchase sequences is greater than a certain value, and calculate the utility and utility confidence of each high utility negative sequential rule; then, store the information obtained from the high utility negative rules in two hash tables respectively, with key1 in the first Hash Table representing the high utility negative sequential rule, value1 representing the utility of the corresponding high utility negative sequential rule and key2 in the second Hash Table representing the high utility negative sequential rule and value2 representing the utility confidence of the corresponding high utility negative sequential rule. For example, as for the high utility negative sequential rule R=a¬b⇒d (utility=1350, uconf=80%), it means the customers has bought commodity A first, no commodity B, and then commodity D and spends a total of 1350 CNY in the utility sequence database with utility confidence of 80%. Under the premise of a minimum utility of 1000 and a minimum utility confidence of 60%, we can conclude that: when it is found that a customer has bought commodity A but no commodity B, if we timely recommend commodity D to the customer, we will have an 80% chance to get a higher profit.

The utility sequence database in Step A is transformed from the database obtained after the data classification in Step (3). The specific method is as follows: First, find all the shopping behavior data containing the customer ID from the database with the customer ID as the primary key, wherein the customer's shopping behavior data refer to the data given back to the said commodity recommendation module by the said commodity sales module via the said third information transmission module, including timestamp, customer ID, commodity ID, quantity, and unit price; then, combine the shopping behavior data with the same customer ID, namely remove the timestamp (shopping time), keep the customer ID as the first field, and make up the second field by sorting the commodities purchased by the customer in chronological order by ID and quantity; additionally, the unit price of each commodity will be kept separately; thus, the utility sequence database corresponding to different genders and different age intervals is obtained.

The following is an example of how to obtain a utility sequence database from the customers' shopping behavior data. Table 1 shows a transaction database sorted by the transaction ID, transaction time, customer ID, commodity, quantity, and unit price as keywords. In such a transaction database, a transaction represents a shopping record, a single item represents a commodity purchased by a customer, and the letter in the item attribute records the commodity ID. For example, T3 denotes that the customer C3 bought 5 commodity b and 3 commodity e at 8:02:12 on Dec. 4, 2019, wherein the unit prices of commodity b and commodity e are 5 and 6 respectively.

Transform the transaction database containing the customers' shopping behavior data into a utility sequence database in time order. For example, transform the transaction database in Table 3 into the sequence database in Table 4 and the utility table in Table 5.

TABLE 3

| Transaction | | Customer | Com- | | Unit |
|---|---|---|---|---|---|
| ID | Transaction time | ID | modity | Quantity | price |
| T1 | Dec. 4, 2019 8:00:00 | C1 | a | 1 | 9 |
| T2 | Dec. 4, 2019 8:01:05 | C2 | b, c, d | 2, 3, 1 | 5, 2, 1 |
| T3 | Dec. 4, 2019 8:02:12 | C3 | b, e | 5, 3 | 5, 6 |
| T4 | Nov. 5, 2020 10:03:16 | C2 | a, d | 2, 5 | 9, 1 |
| T5 | Dec. 6, 2020 10:04:35 | C3 | a | 3 | 9 |
| T6 | Dec. 7, 2020 10:04:35 | C1 | c, e | 3, 5 | 2, 6 |

TABLE 4

| Customer ID | Customer shopping sequence |
|---|---|
| C1 | <(a, 1){(c, 3)(e, 5}> |
| C2 | <{(b, 2)(c, 3)(d, 1)}{(a, 2)(d, 5)}> |
| C3 | <{(b, 5)(e, 3)}(a, 3)> |

TABLE 5

| Item | a | b | c | d | e |
|---|---|---|---|---|---|
| Unit utility | 9 | 5 | 2 | 1 | 6 |

In table 4, all the shopping records of a customer in a certain period form an ordered sequence which is denoted as < >. In the sequence, items/elements are in chronological order. Each item represents a commodity, while each element refers to the commodities that are purchased by the customer simultaneously at a specific time point, represented by { }. For example, {(c,3)(e,5} represents that a customer has bought 3 commodity c and 5 commodity e simultaneously. Each item is followed by a number, which is referred to as internal utility, representing the quantity of commodity that the customer purchased at that time, while each item also has its own value which is referred to as unit utility (external utility). As shown in Table 5, for example, each commodity a is worth 9 yuan.

The mining of high utility negative sequential rules from the utility sequence database through the high utility negative sequential rules mining method and the e-HUNSR algorithm in Step A comprises steps as follows:
a. Utilize the HUNSPM algorithm to mine the utility sequence database to get all the high-utility negative sequential patterns and save their utility values, wherein the high-utility negative sequential pattern refers to a utility negative sequential pattern with a utility being greater than or equal to the minimum utility; For example, given the utility of <a¬bcd¬e> as 20, then it is right a high-utility negative sequential pattern if the minimum utility is set as 18.
b. Obtain all candidate rules based on the high-utility negative sequential patterns generated by Step a, following the specific method as follows: divide the high-utility negative sequential pattern into two parts, namely the front part and the rear part; for example, the candidate rules corresponding to <a¬bcd¬e> are: a⇒¬bcd¬e, a¬b⇒cd¬e, a¬bc⇒d¬e, and a¬bcd⇒¬e.
c. Delete the candidate rule wherein its front part or rear part contains only one negative item; for example, among the candidate rules corresponding to <a¬bcd¬e>, the rule a¬bcd⇒¬e should be deleted, as its rear part contains only one negative item, while the other candidate rules shall be preserved.
d. Calculate the utility confidence of the remaining candidate rules, and those with utility confidence larger than the minimum utility confidence are right the desired high utility negative sequential rules.

Table 6 shows part of the high utility negative sequential rules and their utility and utility confidence. For example, as for a high utility negative sequential rule R=<Walnut kernel¬Spicy hot dried bean curd>⇒<PecanWalnut kernel>(utility=534, uconf=0.64), it means that a customer in the utility sequence database bought Walnut kernel first, no spicy hot dried bean curd, and then pecan and walnut kernel, and spent a total of 534 CNY and the utility confidence is 0.64. Under the premise of a minimum utility of 300 and a minimum utility confidence of 55%, we can conclude that: when it is found that a customer has bought walnut kernel but no spicy hot dried bean curd, if we timely recommend pecan and walnut kernel to the customer, we will have a 64% chance to get a higher profit. The utility sequence database is transformed from the database obtained after the data classification. The specific method is as follows: First, find all the shopping behavior data containing the customer ID from the database with the customer ID as the primary key; then, combine the shopping behavior data with the same customer ID, namely remove the timestamp (shopping time), keep the customer ID and make up the second field by sorting the commodities purchased by the customer in chronological order by ID and quantity; thus, the utility sequence database corresponding to different genders and different age intervals is obtained.

TABLE 6

| High utility negative sequential rule (HUNSR) | utility | uconf |
|---|---|---|
| <Walnut kernel¬Spicy hot dried bean | 525 | 0.64 |
| curd>⇒<PecanWalnut kernel> | | |
| <¬Dried mangoPecan>⇒<Walnut kernel> | 330 | 0.75 |
| <Dried strawberry>⇒<Dried mango¬Spicy hot | 346 | 0.80 |
| dried bean curd> | | |
| <Walnut kernel¬Spicy hot dried bean | 434 | 0.56 |
| curd>⇒<Pecan> | | |
| . . . | . . . | |

Store the high utility negative sequential rules obtained from Step A in a Hash Table, with the key representing high utility negative sequential rules and the value representing the corresponding utility and utility confidence.

B. Filter the actionable high utility negative sequential rules: filter the high utility negative rules based on support, rule inclusion criteria, and utility; filter each High Utility Negative Rule in the order of support, rule inclusion criteria, and utility, which comprises steps as follows:

Assuming that there are high utility negative sequential rules R=X⇒Y and Ri=Xi⇒Yi, wherein R and Ri represent two different high utility negative sequential rules respectively, X represents the front part of R while Y represents the rear part of R and Xi represents the front part of Ri while Yi represents the rear part of Ri, the high utility negative sequential rule is an actionable high utility negative sequential rule relative to Ri if the following three conditions \textcircled{1}, \textcircled{2} and \textcircled{3} are fulfilled. By deleting all Ri and retaining all R, then all actionable high utility negative sequential rules that fulfill the conditions \textcircled{1}, \textcircled{2} and \textcircled{3}, namely commodity recommendation that meets the customer's needs, can be obtained.
R and Ri have the same support;
When R=X⇒Y is compared with Ri=Xi⇒Yi, Ri⊆R, X⊆Xi, Yi⊆Y;
u(Ri)≤u(R), where u(Ri) refers to the utility of Ri and u(R) refers to the utility of R;

For example, for rules R1: <a¬be>⇒<c d> and R2<a¬be>⇒<c>, R1 and R2 have the same support according to Step \textcircled{1}, so proceed with Step \textcircled{2}; according to Step \textcircled{2}, R2⊆R1, the front part of in contained in that of R2, namely a¬be⊆a¬be, and the rear part of R1 is contained in that of R2, namely c⊆c d, so proceed with Step \textcircled{3}; according to Step \textcircled{3}, R1 has a utility larger than that of R2. To sum up, R1 is an actionable rule relative to R2, so R2 shall be deleted while R1 shall be preserved, and all rules similar to R2 shall be deleted while all those similar to R1 shall be preserved. Then, the actionable high utility negative sequential rules formed by all R1 are right the rules desired by us that can directly recommend products to customers.

The support of R in condition \textcircled{1} shall be calculated with the formula as shown in equation (I):

$$sup ( X ⇒ Y ) = \frac{sup ( X Y )}{\vert D \vert} \qquad ( I )$$

Where: |D| represents the number of tuples in sequence database D, wherein the tuple is expressed as <sid(sequence-ID), ds (data sequence)>; sequence-ID, abbreviated as sid, represents the ID of each sequence, for example C1, C2, and C3 in Table 2; data sequence, abbreviated as ds, represents the corresponding sequence; for example, the ds corresponding to C1 is <(a,1){(c,3)(e,5}>, the ds corresponding to C2 is <{(b,2)(c,3)(d,1)}{(a,2)(d,5)}> and the ds corresponding to C3 is <{(b,5)(e,3)}(a,3)>; X∞Y represents the connection between X and Y; sup(X∞Y) represents the number of tuples that contain X∞Y in the sequence database D;

The support of Ri shall be calculated with the formula as shown in equation (II):

$$sup ( X i ⇒ Y i ) = \frac{sup ( Xi Yi )}{\vert D \vert} \qquad ( II )$$

Where: Xi∞Yi the connection between Xi and Yi; sup(Xi∞Yi) represents the number of tuples that contain Xi∞Yi in the sequence database D.

Assuming in condition that R=ac⇒be and Ri=ac⇒b, is <ac⇒b>⊆<ac⇒be>, ac⊆, b⊆be, wherein R and Ri represent two different high utility negative sequential rules respectively, ac represents the front part of R, be represents the rear part of R, ac represents the front part of Ri, and b represents the rear part of Ri, then these two rules satisfy the condition \textcircled{2}.

For the rule R=X⇒Y in condition \textcircled{3}, if <e₁e₂e₃ . . . eᵢ₋₁> represents the front part X and the <eᵢ . . . eₖ> represents the rear part Y, then the rule should be expressed as R=<e₁e₂e₃ . . . eᵢ₋₁>⇒<eᵢ . . . eₖ>;

The utility U® of the rule R shall be calculated with the formula as shown in equation (III):

u(R)=Σᵢ₌₁^{k}u(eᵢ) (III)

Where: i=1, 2, 3 . . . k, eᵢ∈R, u(eᵢ)=q(eᵢ, R)×p(eᵢ) q(eᵢ, R) represents the internal utility of item eᵢ and p(eᵢ) represents the external utility of item eᵢ;

As for the rule Ri=Xi⇒Yi, assuming that <e₁e₂e₃ . . . eⱼ₋₁> represents the front part Xi and <eᵢ . . . eₖ> represents the rear part Yi, then the rule can be expressed as Ri=<e₁e₂e₃ . . . eᵢ₋₁>⇒<eᵢ . . . eₖ>;

The utility u(Ri) of the rule Ri shall be calculated with the formula as shown in equation (IV):

$$u ( R i ) = {\sum }_{j = 1}^{k} u ( {e}_{j} ) \qquad ( IV )$$

Where: j=1, 2, 3 . . . k, eⱼ∈Ri, u(eⱼ)=q(eⱼ, R)×p(eⱼ); q(eⱼ, R) represents the internal utility of item eⱼ and p(eⱼ) represents the external utility of item eⱼ.

Generate all high utility negative sequential rules according to the method. Table 7 shows part of the actionable high utility negative sequential rules. For example: <Walnut kernel¬Spicy hot dried bean curd>⇒<Pecan, Walnut kernel>, <¬Dried mango, Pecan>⇒<Walnut kernel>, and <Dried strawberry>⇒<Dried mango¬Spicy hot dried bean curd> etc. For the rule marked with a strikeout ( [symbol] [symbol] ), it means that the rule has been deleted after filtering by steps \textcircled{1}-\textcircled{3}. The reasons for deletion are as follows:

Refer to <Walnut kernel¬Spicy hot dried bean curd>⇒<PecanWalnut kernel> as R1 and [symbol] as R2. R1 and R2 have the same support according to Step \textcircled{1}, so proceed with Step \textcircled{2}; according to Step \textcircled{2}, the front part of R1 is contained in that of R2 and the rear part of R1 is contained in that of R2, so proceed with Step \textcircled{3}; according to Step \textcircled{3}, R1 has a utility larger than that of R2. To sum up, R1 is an actionable rule relative to R2, so R2 shall be deleted while R1 shall be preserved.

TABLE 7

| Actionable high utility negative | | |
|---|---|---|
| sequential rule (AUNSR) | support | utility |
| <Walnut kernel¬Spicy hot dried bean | 0.24 | 525 |
| curd>⇒<Pecan, Walnut kernel> | | |
| <¬Dried mango, Pecan>⇒<Walnut kernel> | 0.25 | 330 |
| <Dried strawberry>⇒<Dried mango¬Spicy hot | 0.30 | 246 |
| dried bean curd> | | |
| . . . | | . . . |

Algorithm pseudocode

INPUT: Utility sequence database (D), minimum utility (min_utility),
minimum utility confidence (min_uconf);
OUTPUT: Actionable high utility negative sequential rules (AUNSRs)
Mine all high utility negative sequential rules (HUNSRs) by e-HUNSR
algorithm;
AUNSRset←(HUNSRs);
FOR(Rᵢ:Xᵢ⇒Yᵢ and Rᵢ₊₁: Xᵢ₊₁⇒Yᵢ₊₁in AUNSRset){
IF(supp (Rᵢ) = supp (Rᵢ₊₁)){//Step \textcircled{1}
IF(Rᵢ₊₁⊂Ri∩Xi⊂Xᵢ₊₁∩Yᵢ₊₁⊂Yᵢ){//Step \textcircled{2}
IF(u(Rᵢ₊₁)≤u(Rᵢ)){//Step\textcircled{3}
Eliminate Rᵢ₊₁
}END OF LINE(6)
}END OF LINE(5)
}END OF LINE(4)
}END FOR

Return AUNSRset;

Step (1) mines all high utility negative sequential rules by e-HUNSR algorithm;

Step (2) stores all high utility negative sequential rules in set AUNSRset;

Step (4) filters the rules according to the support;

Step (5) filters the rules according to the rule inclusion criteria;

Step (6) filters the rules according to the utility;

Step (7) removes the redundant rules;

Step (12) returns the set AUNSRset.

1-10. (canceled)

11. A commodity recommendation system based on actionable high utility negative sequential rules mining, which is characterized in that it comprises information acquisition module, commodity recommendation module and commodity sales module connected sequentially through the transmission network communication;
the said information acquisition module comprises information extraction module and the first information transmission module which are sequentially connected;
the said information extraction module is used to: extract and store in real time the customer behavior data which includes customer ID, face mark, age, gender, timestamp, and mark of the commodity browsed by the customer. The said first information transmission module is used to: transmit the customers' behavior data to the said commodity recommendation module through the transmission network;
the said commodity recommendation module comprises information processing module, information analysis module, display module, and the second information transmission module which are connected sequentially; the said commodity recommendation module is set up in the cloud server, with the said first information transmission module connecting to the said information processing module;
the said information processing module is used to: conduct data cleaning for the collected customer behavior data and classify the data after such cleaning. The said information analysis module is used to: analyze and forecast the customers' shopping behaviors according to the treatment results of the said information processing module. The specific process is as follows: the said information analysis module creates a shopping behavior sequence corresponding to the customer ID based on the customer behavior data treated by the said information processing module and then analyzes and predicts the shopping behaviors; the shopping behavior data of customers of the same sex and in the same age range constitute a sequence database, with each customer ID corresponding to an ordered sequence formed by all the shopping records of a customer during a certain period of time; then, the module will conduct data mining for the sequence database to get desirable actionable high utility negative sequential rules, namely commodity recommendation that meets the customer's needs. the said information analysis module analyzes and predicts the customer behavior data through the AUNSRM algorithm in Step (4), which comprises steps as follows:
A) mine the utility sequence database through the high utility negative sequential rule mining method and the e-HunSR algorithm to obtain all high utility negative sequential rules, which are rules that the value of customer's purchase sequences is greater than a certain value, and calculate the utility and utility confidence of each high utility negative sequential rule; then, store the information obtained from the high utility negative rules in two hash tables respectively, with key1 in the first Hash Table representing the high utility negative sequential rule, value1 representing the utility of the corresponding high utility negative sequential rule and key2 in the second Hash Table representing the high utility negative sequential rule and value2 representing the utility confidence of the corresponding high utility negative sequential rule;
B) filter the actionable high utility negative sequential rules: filter the high utility negative rules based on support, rule inclusion criteria, and utility; filter each High Utility Negative Rule in the order of support, rule inclusion criteria, and utility, which comprises steps as follows:
assuming that there are high utility negative sequential rules R=X⇒Y and Ri=Xi⇒Yi, wherein R and Ri represent two different high utility negative sequential rules respectively, X represents the front part of R while Y represents the rear part of R, and Xi represents the front part of Ri while Yi represents the rear part of Ri, the high utility negative sequential rule R is an actionable high utility negative sequential rule relative to Ri if the following three conditions (a), (b) and (c) are fulfilled. By deleting all Ri and retaining all R, then all actionable high utility negative sequential rules that fulfill the conditions (a), (b) and (c), namely commodity recommendation that meets the customer's needs, can be obtained;
(a): R and Ri have the same support;
(b): When R=X⇒Y is compared with Ri=Xi⇒Yi, Ri⊆R, X⊆Xi, Yi⊆Y;
(c): u(Ri)≤u(R), where u(Ri) refers to the utility of Ri and u(R) refers to the utility of R;
the said display module is used to: display the recommendation results for the customer, including the commodity ID, model, quantity, and unit price, and adds them to the shopping cart if the customer is satisfied; otherwise, the recommendation results will be discarded; the said second information transmission module is used to: transmit the treatment results of the said commodity recommendation module to the said commodity sales module through the transmission network;
the said commodity sales module comprises settlement module, inventory update module, and the third information transmission module which are connected sequentially;
the said commodity sales module is set up in the cloud server, with the said third information transmission module used to connect the said commodity recommendation module; the said settlement module used to: settle accounts for the commodities in the shopping cart according to the treatment results of the said commodity recommendation module while the customer is going to the checkout counter for settlement; and the said inventory update module used to: update the commodity inventory in real time after the order is successfully settled; additionally, the said commodity sales module also caches the customer's shopping behavior data this time and gives back the shopping record in real time to the said commodity recommendation module via the said third information transmission module.

12. The commodity recommendation system based on actionable high utility negative sequential rules mining according to claim 11, which is characterized in that the said transmission network can be a wired network, LAN, Wi-Fi, personal network, or 4G/5G network.

13. A working method of the commodity recommendation system based on actionable high utility negative sequential rules mining according to claim 11, which is characterized in that it comprises steps as follows:
(i) the said information extraction module extracts and stores in real time the customer behavior data which includes customer ID, face mark, gender, age, timestamp, and mark of the commodity browsed by the customer. Among them, face marks include whether to wear glasses and the coordinate positions of the eyes;
(ii) the said first information transmission module transmits the customer behavior data extracted by the information acquisition module as said in Step (i) to the said commodity recommendation module through the transmission network;
(iii) the said information processing module conducts data cleaning for the collected customer behavior data and classifies the data after such cleaning;
(iv) the said information analysis module analyzes and predicts the customers' shopping behaviors according to the treatment results of the said information processing module; the specific process is as follows: the said information analysis module creates a shopping behavior sequence corresponding to the customer ID based on the customer behavior data treated by the said information processing module and then analyzes and predicts the shopping behaviors; the shopping behavior data of customers of the same sex and in the same age range constitute a sequence database, with each customer ID corresponding to an ordered sequence formed by all the shopping records of a customer during a certain period of time; then, the module will conduct data mining for the sequence database to get the desirable actionable high utility negative sequential rules, namely commodity recommendation that meets the customers' needs;
(v) based on the commodity recommendation in line with the customer's needs obtained from Step (4), the said display module displays the recommendation results for the customer, including the commodity ID, model, quantity, and unit price, and adds them to the shopping cart if the customer is satisfied; otherwise, the recommendation results will be discarded;
(vi) the said second information transmission module transmits the treatment results of the said commodity recommendation module to the said commodity sales module through the transmission network;
(vii) while the customer is going to the checkout counter for settlement, the said settlement module settles accounts for the commodities in the shopping cart according to the treatment results of the said commodity recommendation module; then, the said inventory update module updates the commodity inventory in real time after the order is successfully settled; the said commodity sales module also caches the customer's shopping behavior data this time and gives back the shopping record in real time to the said commodity recommendation module via the said third information transmission module.

14. The working method of the commodity recommendation system based on actionable high utility negative sequential rules mining according to claim 13, which is characterized in that the utility sequence database in Step A is transformed from the database obtained after the data classification in Step (iii); the specific method is as follows: first, find all the shopping behavior data containing the customer ID from the database with the customer ID as the primary key, wherein the customer's shopping behavior data refer to the data given back to the said commodity recommendation module by the said commodity sales module via the said third information transmission module, including timestamp, customer ID, commodity ID, quantity, and unit price; then, combine the shopping behavior data with the same customer ID, namely remove the timestamp (shopping time), keep the customer ID as the first field, and make up the second field by sorting the commodities purchased by the customer in chronological order by ID and quantity; additionally, the unit price of each commodity will be kept separately; thus, the utility sequence database corresponding to different genders and different age intervals is obtained.

15. The working method of the commodity recommendation system based on actionable high utility negative sequential rules mining according to the claim 13, which is characterized in that the mining of high utility negative sequential rules from the utility sequence database through the high utility negative sequential rules mining method and the e-HUNSR algorithm in Step A) comprises steps as follows:
a. utilize the HUNSPM algorithm to mine the utility sequence database to get all the high-utility negative sequential patterns and save their utility values, wherein the high-utility negative sequential pattern refers to a utility negative sequential pattern with a utility being greater than or equal to the minimum utility;
b. obtain all candidate rules based on the high-utility negative sequential patterns generated by Step A), following the specific method as follows: divide the high-utility negative sequential pattern into two parts, namely the front part and the rear part;
c. delete the candidate rule wherein its front part or rear part contains only one negative item;
d. calculate the utility confidence of the remaining candidate rules, and those with utility confidence larger than the minimum utility confidence are right the desired high utility negative sequential rules.

16. The working method of the commodity recommendation system based on actionable high utility negative sequential rules mining according to the claim 13, which is characterized in that the support of R in condition (a) shall be calculated with the formula as shown in equation (I):
$$sup ( X ⇒ Y ) = \frac{sup ( X Y )}{\vert D \vert} \qquad ( I )$$
where: |D| represents the number of tuples in sequence database D, wherein the tuple is expressed as <sid(sequence-ID), ds (data sequence)>; sequence-ID, abbreviated as sid, represents the ID of each sequence; data sequence, abbreviated as ds, represents the corresponding sequence; X [symbol] Y represents the connection between X and Y; sup(X [symbol] Y) represents the number of tuples that contain X [symbol] Y in the sequence database D;
The support of Ri shall be calculated with the formula as shown in equation (II):
$$sup ( X i ⇒ Y i ) = \frac{sup ( Xi Yi )}{\vert D \vert} \qquad ( II )$$
where: Xi [symbol] Yi represents the connection between Xi and Yi; sup(Xi [symbol] Yi) represents the number of tuples that contain Xi [symbol] Yi in the sequence database D.

17. The working method of the commodity recommendation system based on actionable high utility negative sequential rules mining according to the claim 13, which is characterized in that assuming in condition (b) that R=ac⇒be and Ri=ac⇒b, if <ac⇒b>⊆<ac⇒be>, ac⊆ac, b⊆be, wherein R and Ri represent two different high utility negative sequential rules respectively, ac represents the front part of R, be represents the rear part of R, ac represents the front part of Ri, and b represents the rear part of Ri, then these two rules satisfy the condition (b).

18. The working method of the commodity recommendation system based on actionable high utility negative sequential rules mining according to the claim 13, which is characterized in that for the rule R=X⇒Y in condition (c), if <e₁e₂e₃ . . . eᵢ₋₁> represents the front part X and the <eᵢ . . . eₖ> represents the rear part Y, then the rule should be expressed as R=<e₁e₂e₃ . . . eᵢ₋₁>⇒<eᵢ . . . eₖ>;
the utility u(R) of the rule R shall be calculated with the formula as shown in equation (III):
u(R)=Σᵢ₌₁^{k}u(eᵢ) (III)
where: i=1, 2, 3 . . . k, eᵢ∈R, u(eᵢ)=q(eᵢ, R)×p(eᵢ); q(eᵢ, R) represents the internal utility of item eᵢ and p(eᵢ) represents the external utility of item eᵢ;
as for the rule Ri=Xi⇒YI, assuming that <e₁e₂e₃ . . . eⱼ₋₁> represents the front part Xi and <eⱼ . . . eₖ> represents the rear part Yi, then the rule can be expressed as Ri=<e₁e₂e₃ . . . eⱼ₋₁>⇒<eⱼ . . . eₖ>;
the utility u(Ri) of the rule Ri shall be calculated with the formula as shown in equation (IV):
$$u ( Ri ) = {\sum }_{j = 1}^{k} u ( {e}_{j} ) \qquad ( IV )$$
where: j=1, 2, 3 . . . k, eⱼ∈Ri, u(eⱼ)=q(eⱼ, R)×p(eⱼ); q(eⱼ, R) represents the internal utility of item eⱼ and p(eⱼ) represents the external utility of item eⱼ.

19. The working method of the commodity recommendation system based on actionable high utility negative sequential rules mining according to claim 13, which is characterized in that the data cleaning for the collected customer behavior data conducted by the said information processing module in Step (iii) is a specific process as follows:
For missing data, the range of missing data is determined, the unwanted fields are removed, and the missing content is filled in; for duplicate data, delete the others and retain only one; for inconsistent data, conduct data filling;
the classification of the cleaned data based on the gender and age of the customers in Step (iii) is a specific process as follows: the behavior data of customers of the same sex and in the same age range make up a database, while the behavior data of customers of different genders or different age groups make up different databases which are independent of each other and each of which contains all the behavior data of this type of customers.
